(19) United States
(12) Patent Application Publication
(10) Pub. No.: US 2016/0379321 A1
(43) Pub. Date: Dec. 29, 2016

(54) REAL ESTATE OR OTHER SEARCH METHOD AND APPARATUS

(71) Applicant: Lennar Pacific Properties Management, Inc., Miami, FL (US)

(72) Inventors: John Abraham, Irvine, CA (US); John Greer, San Diego, CA (US); Kevin McHugh, Chapel Hill, NC (US)

(21) Appl. No.: 15/194,286

(22) Filed: Jun. 27, 2016

Related U.S. Application Data
(60) Provisional application No. 62/184,677, filed on Jun. 25, 2015.
(60) Provisional application No. 62/184,644, filed on Jun. 25, 2015.

(51) Int. Cl. G06Q 50/16; G06Q 30/06; G06F 17/30

(52) U.S. Cl. CPC G06Q 50/16; G06F 17/30241; G06F 17/30554; G06F 17/30061; G06Q 30/0627; G06Q 30/0643

(57) ABSTRACT

A software application for execution upon an electronic device (e.g., large display kiosk, a smartphone, etc.) for a consumer of real estate. The software application provides to the user information, statistics, or other data regarding real estate or associated geographic regions based upon user criteria. The software application may allow multiple simultaneous search results to be run on a single display screen. The software application may also be configured to allow a user to make payments associated with a real estate property and/or request service associated with a real estate property. Advertisement capabilities may be included with the software application to rank, display, or otherwise provide information to the user base of the software application.

### CROSS REFERENCE TO RELATED APPLICATIONS

This application claims the benefit of U.S. Provisional Patent Application Ser. No. 62/184,644, filed on Jun. 25, 2015, entitled “REAL ESTATE SEARCH METHOD AND APPARATUS,” which is hereby incorporated by reference in its entirety. This application also claims the benefit of U.S. Provisional Patent Application Ser. No. 62/184,677, filed on Jun. 25, 2015, entitled “USER INTERFACEABLE KIOSK OR INFORMATION APPARATUS,” which is hereby incorporated by reference in its entirety.

### BACKGROUND

1. Field of the Invention

The present invention relates to software or a method and apparatus for allowing a user to interface with software for customizing an existing or potentially manufactured real estate property. More particularly, the present invention relates to a mobile or other software application for allowing a user to communicate therewith, such communication interpreted by the mobile or other software application in order to return visual customizations to the user regarding a one or more specific real estate properties.

2. Description of the Related Art

The home search or real estate market is a large business both in the United States and Worldwide, linking potential customers of a large variety of real estate properties (e.g., single family homes, apartment homes, condominiums, land, business leases, etc.) with a vast array of information about such properties. Typically, a potential customer has one or more criteria of particular interest when shopping for a new residence (e.g., price, geographic location, square footage, etc.) and can either communicate with a real estate agent and/or browse different real estate management or agent webpages online in an effort to locate a desirable home. Unfortunately, this process is generally time consuming and inefficient, as a user may have to examine different real estate property web pages or talk to a number of different property agents to determine information or availability. For example, if a potential customer is interested in units at a first apartment complex and a second apartment complex, the user may be required to browse a different webpage for each and/or talk to different agents at each respective complex in order to determine what units are available and their characteristics. This may occur even when the two apartment complexes are commonly owned by one company or business.

Thus, there is a need for an improved method and/or apparatus for allowing customers to search and/or otherwise locate properties or information about properties that may be of interest for rent, purchase, or lease. Ideally, this method and/or apparatus would incorporate technology so that potential consumers can view properties and/or their respective amenities online by utilizing one system. The ideal method and/or apparatus would be easy to use, efficient, and provide users with a simple, yet comprehensive, look at properties that match one or more customer criteria.

### SUMMARY

The present invention is related to a method and/or application and/or system for allowing a user to search real estate property in order to view possible options for a property without requiring the user to transfer or move between a plurality of systems to determine information on various properties.

In one embodiment, an apparatus for providing information may include a display configured to receive user input via touch of the display, the display configured to have a first interaction area and a second interaction area wherein a first user can interact with the first interaction area while a second user can simultaneously interact with a second interaction area. The apparatus may also include a memory configured to store data and a processor in communication with the memory and the display and configured to: receive a first search request, determine a portion of the data in the memory that matches the first search request, and transmit to the display at least some of the portion of the data that matches the first search request.

In another embodiment, a method of providing search results for real estate to a user, may include the steps of providing a software application configured to be executed by a processor, providing a memory for storing data corresponding to a plurality of real estate properties, determining, using the processor, a first search request, determining, using the processor, a second search request simultaneously with the determining of the first search request, determining, using the processor, a first data in the memory that matches with the first search request, and displaying information associated with the first data.

In still another embodiment, a method of providing information to a user regarding a property may include providing a software application configured to be executed by a processor, receiving, via the software application, a service request from the user corresponding to the property, displaying, via the software application, confirmation of the service request, receiving, via the software application, a payment from the user for the property, displaying, via the software application, confirmation of the payment, displaying, via the software application, an activity to the user, the activity located within a predetermined geographic proximity to the property, and displaying, via the software application, an advertisement to the user.

### BRIEF DESCRIPTION OF THE DRAWINGS

The features, objects, and advantages of the present invention will become more apparent from the detailed description set forth below when taken in conjunction with the drawings, wherein:

FIG. 1 shows a display screen (e.g., a home screen) of a system implementing a real estate search software application according to one embodiment of the present invention;

FIG. 2 shows a display screen (e.g., a begin search screen) of a system implementing a real estate search software application according to one embodiment of the present invention;

FIG. 3 shows a display screen (e.g., a desired price screen) of a system implementing a real estate search software application according to one embodiment of the present invention;

FIG. 4 shows a display screen (e.g., a desired floor plan screen) of a system implementing a real estate search software application according to one embodiment of the present invention;

FIG. 5 shows a display screen (e.g., a desired move date screen) of a system implementing a real estate search software application according to one embodiment of the present invention;

FIG. 6 shows a display screen (e.g., a desired move date screen) of a system implementing a real estate search software application according to one embodiment of the present invention;

FIG. 7 shows a display screen (e.g., a suggested homes screen) of a system implementing a real estate search software application according to one embodiment of the present invention;

FIG. 8 shows a display screen (e.g., a 2D floor plan screen) of a system implementing a real estate search software application according to one embodiment of the present invention;

FIG. 9 shows a display screen (e.g., a residence photograph screen) of a system implementing a real estate search software application according to one embodiment of the present invention;

FIG. 10 shows a display screen (e.g., a 3D floor plan screen) of a system implementing a real estate search software application according to one embodiment of the present invention;

FIG. 11A shows a display screen (e.g., a residence photograph screen) of a system implementing a real estate search software application according to one embodiment of the present invention;

FIG. 11B shows the display screen (e.g., a residence photograph screen) of FIG. 11A having additional user interface options according to one embodiment of the present invention;

FIG. 12A shows a display screen (e.g., a suggested homes screen) of a system implementing a real estate search software application according to one embodiment of the present invention;

FIG. 12B shows the display screen (e.g., a suggested homes screen) of FIG. 12A having additional user notification options according to one embodiment of the present invention;

FIG. 12C shows the display screen (e.g., a suggested homes screen) of FIG. 12A or FIG. 12B after user notification selection according to one embodiment of the present invention;

FIG. 13 shows a display screen (e.g., an areas of interest screen) of a system implementing a real estate search software application according to one embodiment of the present invention;

FIG. 14 shows a display screen (e.g., a home amenities screen) of a system implementing a real estate search software application according to one embodiment of the present invention;

FIG. 15 shows a display screen (e.g., a home amenities screen) of a system implementing a real estate search software application according to one embodiment of the present invention; and

FIG. 16 shows a block diagram of a system implementing a real estate search software application according to one embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

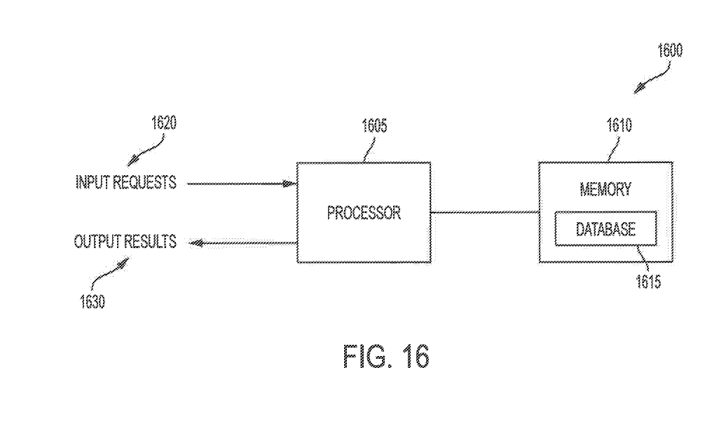

Initially turning to FIG. 16, a block diagram of a system 1600 is shown that may implement a home or real estate search and/or information provision software application. For example, the software application may include features that are the same as or similar to those discussed throughout. The system 1600 includes a processor 1605 connected with a memory 1610, the memory 1610 configured to store data. The processor is configured to interface or otherwise communicate with the memory, for example, via electrical signals propagated along a conductive trace or wire. In an alternative embodiment, the processor 1605 may interface with the memory 1610 via a wireless connection. In one embodiment, the memory 1610 may include a database 1615, a plurality of data or entries capable of being stored in the database 1615 of the memory 1610. For example, as discussed in greater detail herein, the memory 1610 and/or the database 1615 may store information about real estate properties that may be accessed and/or retrieved and/or sent to a user based upon user requests and/or criteria.

As discussed in greater detail herein, the processor 1605 may be tasked with executing software or other logical instructions in order for the software application to function as desired. Input requests 1620 may be received by the processor 1605 (e.g., via signals transmitted from a user at a remote system or device, such as a handheld device like a smartphone, tablet, or other computing device, to the processor 1605 via a network or Internet connection). In an alternative embodiment, the input requests 1620 may be received by the processor via a user input device that is not at a geographically remote location (e.g., via a connected keyboard, mouse, touchpad, touchscreen, etc. at a local area or computer terminal). After performing tasks or instructions based upon the user input requests 1620, for example, looking up information or data stored in the memory 1610, the processor 1605 may output results 1630 back to the user that are based upon the input requests 1620. In an alternative embodiment, any of a variety of systems capable of receiving input data, accessing stored data, processing software instructions, and/or transmitting output data may be utilized.

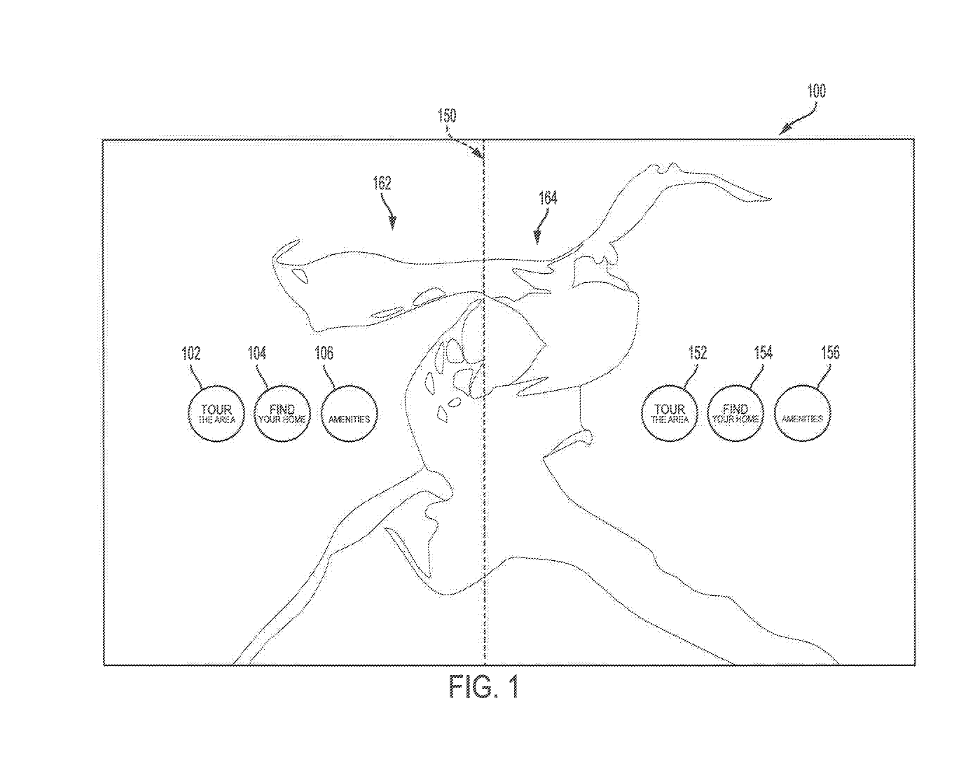

FIG. 1 shows a display screen 100 of a software application for allowing a user to communicate with the software application and obtain relevant results regarding home or real estate properties. Although the software application used in exemplary embodiments throughout corresponds to real estate or other properties, information may be searched for and/or provided to users on any of a variety of possible topics or areas using functionality that is the same as or similar to those concepts disclosed. The software application may be configured to be run or executed using a system having a processor and memory (e.g., system 1600, processor 1605, and/or memory 1610 and/or database 1615 previously discussed for FIG. 16).

One problem with conventional real estate searching for consumers is the lack of consolidated and/or easy to obtain information about potential properties of interest that may require a user to speak with multiple agents and/or visit multiple webpages in order to determine desired information (e.g., available properties at multiple locations, prices, amenities, floor plans, etc.). The display screen 100 of the software application shown in FIG. 1 may help address one or more of these issues by providing a system that may allow a user to search among multiple (e.g., all or some) of a builder's, agent's, and/or other company's or multiple companies properties based upon one or more criteria that may be input by the user.

As shown in the display screen 100, a plurality of interaction areas (162, 164) that separate 150 the display screen 100 into independently interfacable screen space may be present and configured to accept input (e.g., independent or simultaneous input) from one or more users that are interfacing with the system. For example, a first user may be allowed to interact or interface the first interaction area 162 that is positioned on one side (e.g., a left side) of the display screen 100 while a second user may be allowed to interact or interface with the second interaction area 164 that is positioned on another side (e.g., a right side) of the display screen 100. In an alternative embodiment, greater or fewer interaction areas may be disposed on the display screen 100 in any of a variety of areas or positions and/or multiple display screens may span one or more hardware devices (e.g., television or computer monitors) to produce the full display screen 100. As shown, any of a variety of background images, videos, animations, etc. may be disposed upon the display screen 100. These background images, videos, animations, etc. may be different for each interaction area (162, 164) and/or may smoothly transition (e.g., as illustrated, a swirling or moving splash of paint can smoothly move) between the interaction areas (162, 164) such that the display screen 100 appears as one large display with independently interfacable areas that may accommodate multiple users interfacing with the display screen 100 at once in order to perform and/or access different property searches.

As illustrated, the display screen 100 may include three user interface elements (102, 104, 106) located in the first interaction area 162. A first user of the display screen 100 may be allowed to interact with one or more of these user interface elements (102, 104, 106) in order to search for properties and/or otherwise determine information desired for choosing a particular property they may wish to rent or purchase. Similarly, three user interface elements (152, 154, 156) are located in the second interaction area 164. A second user of the display screen 100 may be allowed to search for properties and/or otherwise determine information desired for choosing a particular property they may wish to rent or purchase. For example, the first and second user (e.g., and/or additional users) may be allowed to operate with the display screen 100 simultaneously in their respective interaction areas (162, 164) to perform independent searches or information gathering. In an alternative embodiment, greater or fewer interaction areas and/or user interface elements may be provided for a given display screen 100.

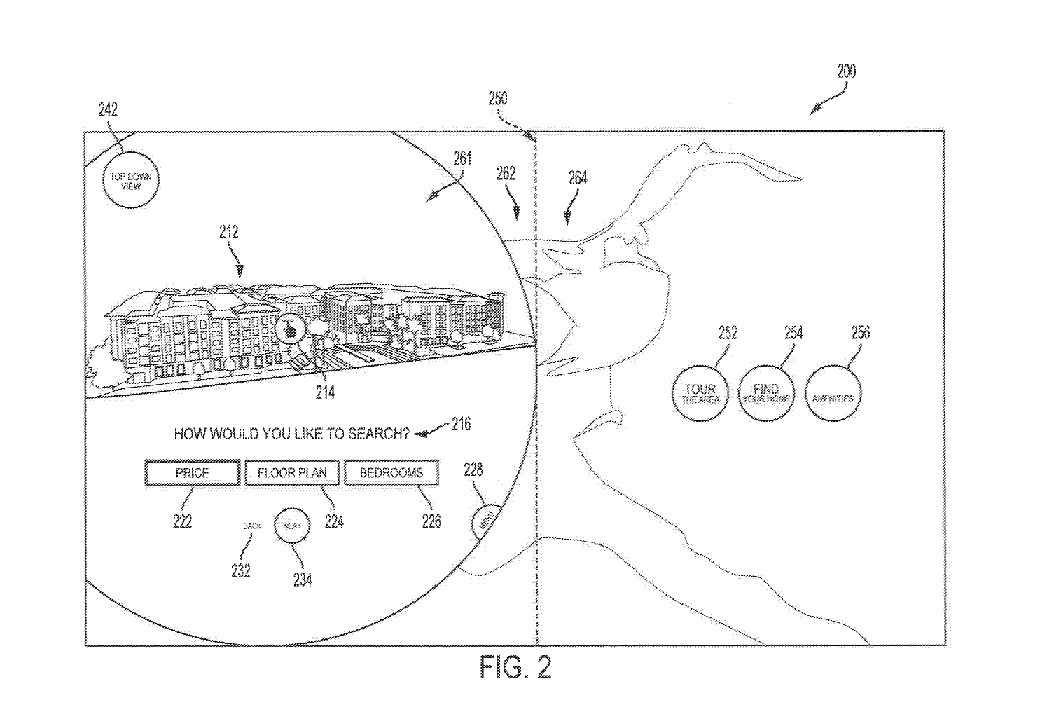

Turning next to FIG. 2, a display screen 200 of a system implementing a real estate search software application is shown. The display screen 200, system, and/or software application may include features that are the same as or similar to those previously discussed. For example, the display screen 200 may be displayed to a user upon receipt of user input indicating that the user desires to find a property with features and/or amenities they find desirable (e.g., by pressing upon one or more user interface elements, such as user interface element 104, previously discussed in FIG. 1). As illustrated, the display screen 200 also includes multiple interaction areas (262, 264) that separate 250 the display screen 200 into independently interfacable screen spaces for accommodating multiple users and/or multiple sessions by a same user, for example, like previously discussed. FIG. 2 shows interaction on the first interaction area 262 while the second interaction area 264 is awaiting further user input (e.g., via user interface elements 252, 254, 256), the same as or similar to previous discussions.

In the first interaction area 262, the display screen 200 shows a graphical depiction 212 of a property (e.g., a particular property of apartment homes). In one embodiment, this graphical depiction 212 may be disposed all or partially within an overlay 261 that may be transparent (e.g., partially transparent) in order for images, animations, videos, etc. to be at least partially viewable therebehind. In one embodiment, the overlay 261 may be in a shape other than rectangular (e.g., may be circular) such that media included within the overlay 261 is cropped within the boundary shape of the overlay 261. A user may be permitted to rotate this graphical depiction 212 by interfacing with user interface element 214 (e.g., touching and sliding the user interface element 214 in the direction of desired rotation). In one embodiment, this graphical depiction may be a three-dimensional object or, in an alternative embodiment, may be a series of two-dimensional images that are rotated or sequenced through as the user interfaces with the user interface element 214. A top down graphical depiction 242 of the property depicted by graphical depiction 212 may also be provided or available in certain embodiments. In some embodiments, a user may be able to interface (e.g., press or click on the top down graphical depiction 242 in order to bring up a list or other display of selectable properties to be shown and/or rotated as described for graphical depiction 212.

The user is provided with a prompt 216, for example, asking how the user would like to proceed with a property search and given one or more user interface elements (222, 224, 226) to select amongst. Greater or fewer user interface elements and/or with alternative criteria may be utilized in an alternative embodiment. A user may also be allowed to interface with navigational user interface elements (232, 234, 228) to move backwards, forward, or to a home screen or menu of the system, respectively. In one embodiment, one or more properties and associated characteristics (e.g., price, address, amenities, etc.) may be stored in a memory and/or database (e.g., the memory 1610 and/or database 1615 previously discussed for FIG. 16) and selected by a processor (e.g., the processor 1605 previously discussed for FIG. 16).

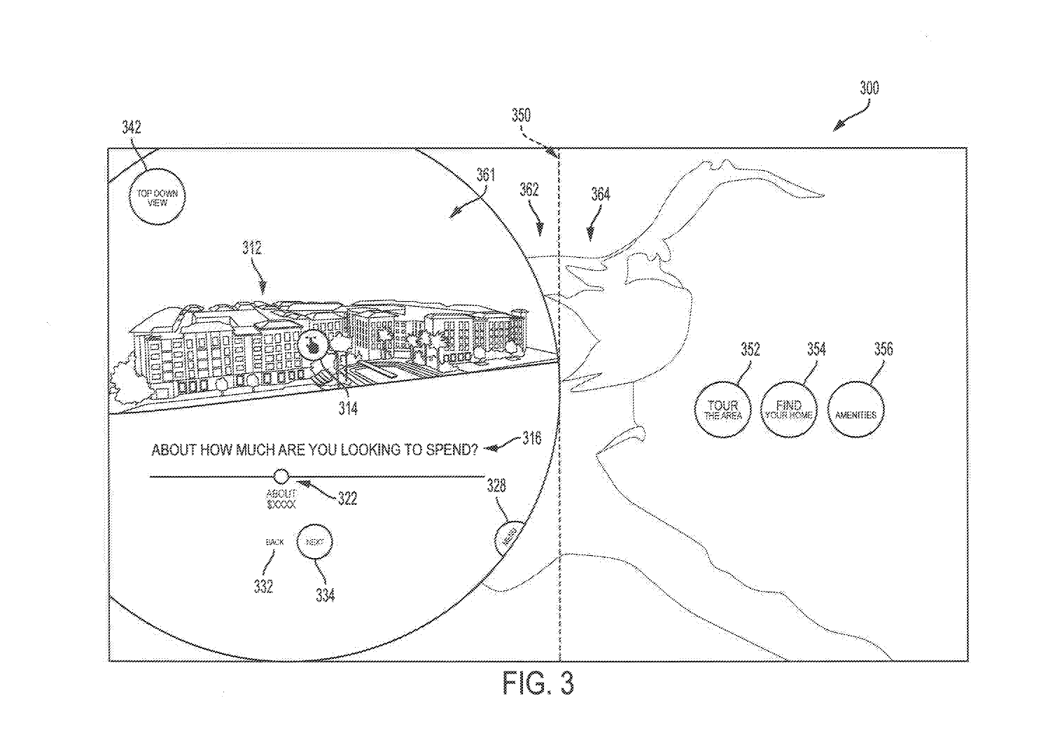

FIG. 3 shows a display screen 300 of a system implementing a real estate search software application. The display screen 300, system, and/or software application may include features that are the same as or similar to those previously discussed. For example, the display screen 300 may be displayed to a user upon receipt of user input indicating that the user desires to find a property by searching via price point (e.g., by pressing upon one or more user interface elements, such as user interface element 222, previously discussed in FIG. 2). As illustrated, the display screen 300 also includes multiple interaction areas (362, 364) that separate 350 the display screen 300 into independently interfacable screen spaces for accommodating multiple users and/or multiple sessions by a same user, for example, like previously discussed. FIG. 3 shows interaction on the first interaction area 362 while the second interaction area 364 is awaiting further user input (e.g., via user interface elements (352, 354, 356), the same as or similar to previous discussions.

In the first interaction area 362, the display screen 300 shows a graphical depiction 312 of a property (e.g., a particular property of apartment homes) that may be disposed all or partially within an overlay 361 that may be transparent (e.g., partially transparent) in order for images, animations, videos, etc. to be at least partially viewable therebehind, the same as or similar to previous discussions. Likewise, a top down graphical depiction 342 and user interface element 314 for rotation of the graphical depiction 312 may be provided, the same as or similar to previous discussions. Similarly, navigation user elements (332, 334, 328) may be provided, the same as or similar to previous discussions.

As illustrated, the display screen 300 includes a prompt 316, for example, asking the user to provide input regarding the price point desired for conducting a home or residence search. In one embodiment, the display screen 300 may include a user interface element 322 that allows for the user to enter a “fuzzy” price criteria (e.g., “about $xxxx”) for the system to use in determining appropriate properties that match the criteria for display or communication to the user. For example, if a user interfaces with the user interface element 322 to select “about $1400” properties that are within a span (e.g., a predetermined or calculated price range near $1400) may be determined and selected as appropriate for communication to the user. Operation of the software application may then continue to display the selected properties to the user and/or to obtain further input to determine criteria for selecting appropriate properties.

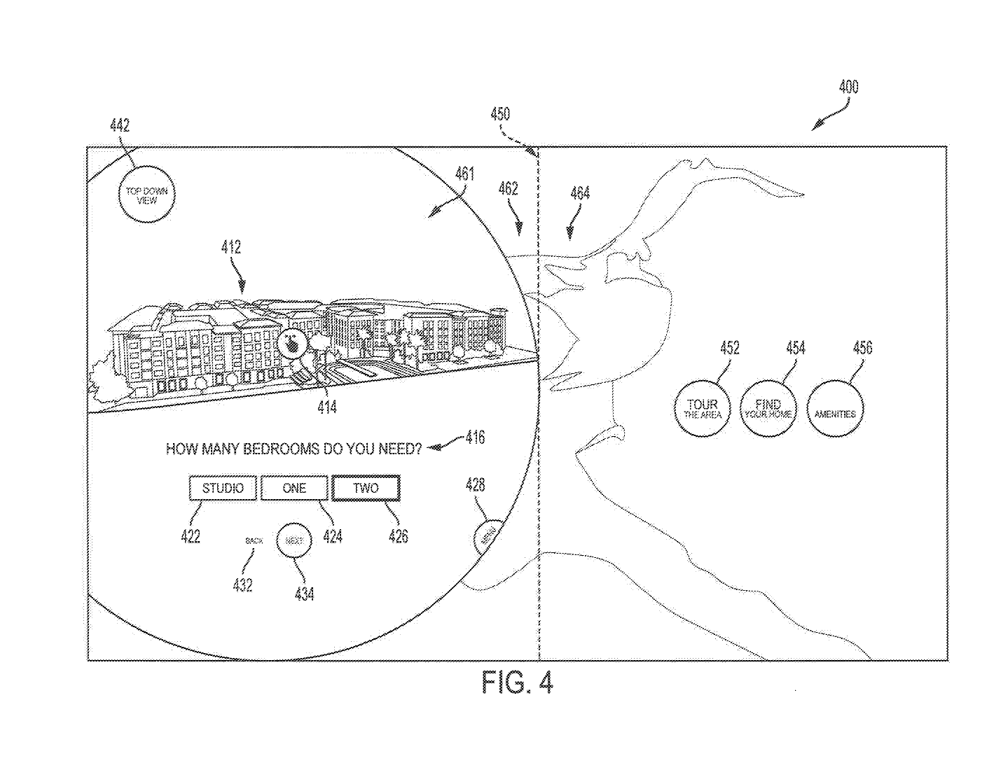

FIG. 4 shows a display screen 400 of a system implementing a real estate search software application. The display screen 400, system, and/or software application may include features that are the same as or similar to those previously discussed. For example, the display screen 400 may be displayed to a user as an initial search criteria screen and/or as a screen for search criteria in addition to other criteria already input to the system, for example, via other display screens such as those previously discussed. As illustrated, the display screen 400 also includes multiple interaction areas (462, 464) that separate 450 the display screen 400 into independently interfacable screen spaces for accommodating multiple users and/or multiple sessions by a same user, for example, like previously discussed. FIG. 4 shows interaction on the first interaction area 462 while the second interaction area 464 is awaiting further user input (e.g., via user interface elements 452, 454, 456), the same as or similar to previous discussions.

In the first interaction area 462, the display screen 400 shows a graphical depiction 412 of a property (e.g., a particular property of apartment homes) that may be disposed all or partially within an overlay 461 that may be transparent (e.g., partially transparent) in order for images, animations, videos, etc. to be at least partially viewable therebehind, the same as or similar to previous discussions. Likewise, a top down graphical depiction 442 and user interface element 414 for rotation of the graphical depiction 412 may be provided, the same as or similar to previous discussions. Similarly, navigation user elements (432, 434, 428) may be provided, the same as or similar to previous discussions.

As illustrated, the display screen 400 includes a prompt 416, for example, asking the user to provide input regarding the number of bedrooms desired for conducting a home or residence search. In one embodiment, the display screen 400 may include user interface elements (422, 424, 426) that allows for the user to interact therewith and choose a desired number and/or type of residence bedroom arrangement for the system to use in determining appropriate properties that match the criteria for display or communication to the user. For example, if a user interfaces with the user interface element 426 to select “two,” properties that correspondingly have two bedrooms may be determined and selected as appropriate for communication to the user. Any of a variety of possible user interface elements or types of user interface elements may be used for determining such user desires. Operation of the software application may then continue to display the selected properties to the user and/or to obtain further input to determine criteria for selecting appropriate properties.

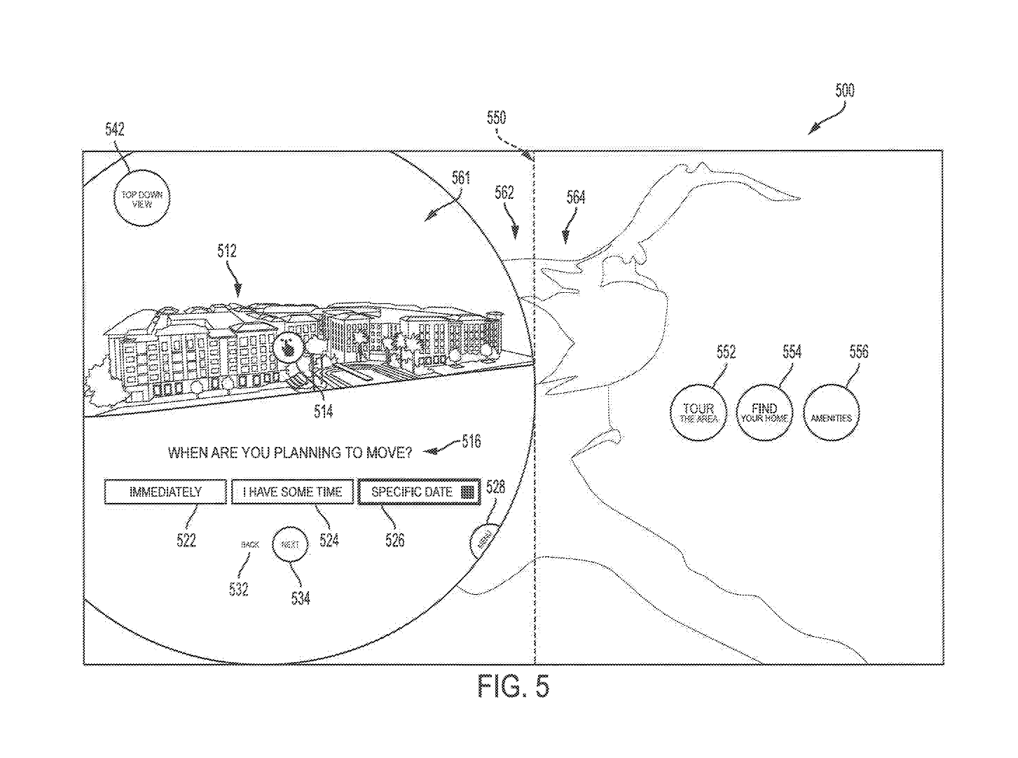

FIG. 5 shows a display screen 500 of a system implementing a real estate search software application. The display screen 500, system, and/or software application may include features that are the same as or similar to those previously discussed. For example, the display screen 500 may be displayed to a user as an initial search criteria screen and/or as a screen for search criteria in addition to other criteria already input to the system, for example, via other display screens such as those previously discussed. As illustrated, the display screen 500 also includes multiple interaction areas (562, 564) that separate 550 the display screen 500 into independently interfacable screen spaces for accommodating multiple users and/or multiple sessions by a same user, for example, like previously discussed. FIG. 5 shows interaction on the first interaction area 562 while the second interaction area 564 is awaiting further user input (e.g., via user interface elements 552, 554, 556), the same as or similar to previous discussions.

In the first interaction area 562, the display screen 500 shows a graphical depiction 512 of a property (e.g., a particular property of apartment homes) that may be disposed all or partially within an overlay 561 that may be transparent (e.g., partially transparent) in order for images, animations, videos, etc. to be at least partially viewable therebehind, the same as or similar to previous discussions. Likewise, a top down graphical depiction 542 and user interface element 514 for rotation of the graphical depiction 512 may be provided, the same as or similar to previous discussions. Similarly, navigation user elements (532, 534, 528) may be provided, the same as or similar to previous discussions.

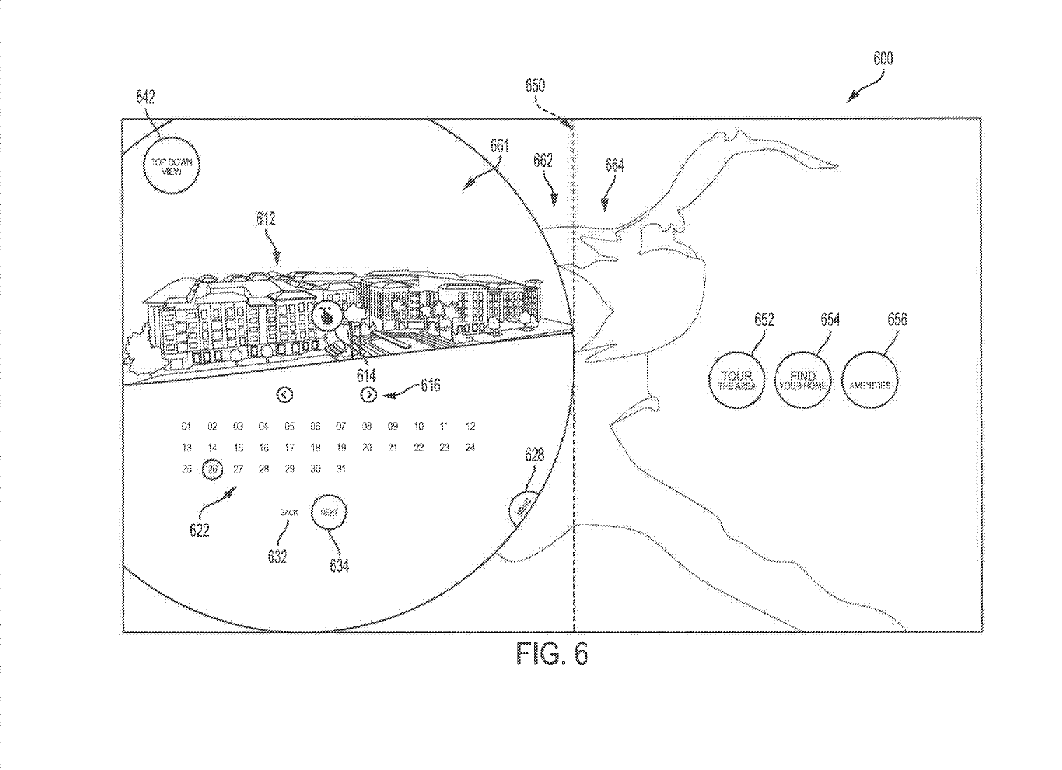

As illustrated, the display screen 500 includes a prompt 516, for example, asking the user to provide input regarding the timeframe desired for moving in to a new residence for conducting a home or residence search. In one embodiment, the display screen 500 may include user interface elements (522, 524, 526) that allows for the user to interact therewith and choose a desired timeframe (e.g., immediately, not immediately, upon a specific date, etc.) for the system to use in determining appropriate properties that match the criteria for display or communication to the user. For example, if a user interfaces with the user interface element 526 to select a specific date desired to move, the user may subsequently be prompted to enter such a date (e.g., see FIG. 6) such that properties that correspondingly are available upon that date for a new resident may be determined and selected as appropriate for communication to the user. Operation of the software application may then continue to display the selected properties to the user and/or to obtain further input to determine criteria for selecting appropriate properties.

FIG. 6 shows a display screen 600 of a system implementing a real estate search software application. The display screen 600, system, and/or software application may include features that are the same as or similar to those previously discussed. For example, the display screen 600 may be displayed to a user as an initial search criteria screen and/or as a screen for search criteria in addition to other criteria already input to the system, for example, via other display screens such as those previously discussed. As illustrated, the display screen 600 also includes multiple interaction areas (662, 664) that separate 650 the display screen 600 into independently interfacable screen spaces for accommodating multiple users and/or multiple sessions by a same user, for example, like previously discussed. FIG. 6 shows interaction on the first interaction area 662 while the second interaction area 664 is awaiting further user input (e.g., via user interface elements 652, 654, 656), the same as or similar to previous discussions.

In the first interaction area 662, the display screen 600 shows a graphical depiction 612 of a property (e.g., a particular property of apartment homes) that may be disposed all or partially within an overlay 661 that may be transparent (e.g., partially transparent) in order for images, animations, videos, etc. to be at least partially viewable therebehind, the same as or similar to previous discussions. Likewise, a top down graphical depiction 642 and user interface element 614 for rotation of the graphical depiction 612 may be provided, the same as or similar to previous discussions. Similarly, navigation user elements (632, 634, 628) may be provided, the same as or similar to previous discussions.

As illustrated, the display screen 600 includes a user interface element 616 (e.g., a selectable calendar) asking the user to provide input 622 regarding a specific timeframe desired for moving in to a new residence for conducting a home or residence search. For example, if a user interfaces with the user interface element 616 to select a specific month, day, and/or year desired to move, properties that correspondingly are available upon that date for a new resident may be determined and selected as appropriate for communication to the user. Operation of the software application may then continue to display the selected properties to the user and/or to obtain further input to determine criteria for selecting appropriate properties.

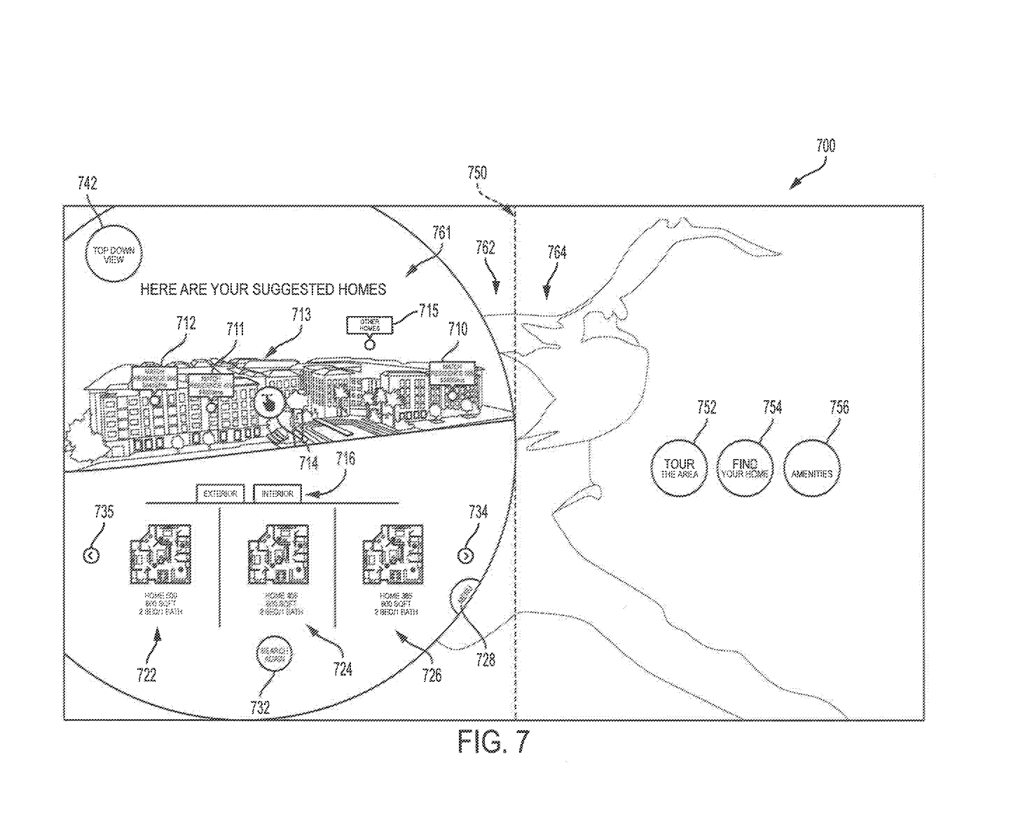

FIG. 7 shows a display screen 700 of a system implementing a real estate search software application. The display screen 700, system, and/or software application may include features that are the same as or similar to those previously discussed. For example, the display screen 700 may be displayed to a user as an initial property results screen and/or as a screen for property results that is displayed after providing overview search results information, for example, via other display screens. As illustrated, the display screen 700 also includes multiple interaction areas (762, 764) that separate 750 the display screen 700 into independently interfacable screen spaces for accommodating multiple users and/or multiple sessions by a same user, for example, like previously discussed. FIG. 7 shows interaction on the first interaction area 762 while the second interaction area 764 is awaiting further user input (e.g., via user interface elements 752, 754, 756), the same as or similar to previous discussions.

In the first interaction area 762, the display screen 700 shows a graphical depiction 713 of a property (e.g., a particular property of apartment homes) that may be disposed all or partially within an overlay 761 that may be transparent (e.g., partially transparent) in order for images, animations, videos, etc. to be at least partially viewable therebehind, the same as or similar to previous discussions. Likewise, a top down graphical depiction 742 and user interface element 714 for rotation of the graphical depiction 713 may be provided, the same as or similar to previous discussions. Similarly, navigation user elements (732, 728) may be provided, the same as or similar to previous discussions. For example, if a user wishes to perform a new search (e.g., with the same and/or different criteria), the user may interface with navigation user element 732.

As illustrated, the display screen 700 includes a plurality of property or residence matches (710, 711, 712) displayed and/or designated upon the graphical depiction 713, the property or residence matches (710, 711, 712) determined via the system by comparing one or more desired user inputs or criteria (e.g., as previously discussed) to store information about one or more properties (e.g., within a memory or database of or connected with the system). Moreover, other properties or homes may be displayed by clicking on interface element 715. The graphical depiction 713 may be rotated and the property or residence matches (710, 711, 712) may similarly rotate or update (e.g., relocate) so as to properly indicate the position of the property within the graphical depiction 713, for example, so that the user may be aware of the precise location of the unit within the apartment complex. In certain embodiments, additional information about a particular property or residence match (710, 711, 712) may be displayed or otherwise communicated to a user if the user interfaces (e.g., presses) upon the property or residence match (710, 711, 712).

In addition, as illustrated, more detailed views or information about each property or residence match (710, 711, 712) may be displayed (722, 724, 726) adjacent to the graphical depiction 713 (e.g., via a top-down or floor plan view). Navigation elements (734, 735) may allow a user to cycle and/or scroll through a plurality of properties if the property or residence match (710, 711, 712) do not all fit upon one screen. Moreover, as illustrated, user interface elements 716 may allow the user to view additional graphic depictions (e.g., updating or changing the elements displayed (722, 724, 726)) to show or highlight additional features of the property or residence matches (710, 711, 712).

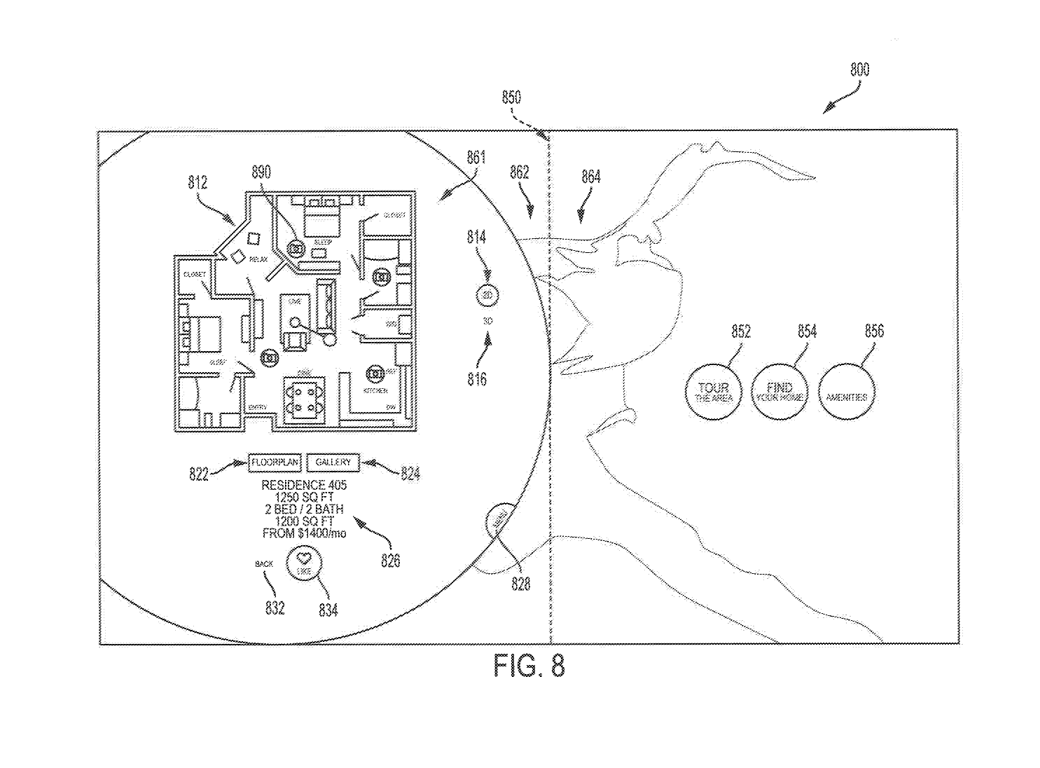

FIG. 8 shows a display screen 800 of a system implementing a real estate search software application. The display screen 800, system, and/or software application may include features that are the same as or similar to those previously discussed. For example, the display screen 800 may be displayed to a user as an initial property results screen and/or as a screen for property results that is displayed after providing overview search results information, for example, via other display screens such as those previously discussed. As illustrated, the display screen 800 also includes multiple interaction areas (862, 864) that separate 850 the display screen 800 into independently interfacable screen spaces for accommodating multiple users and/or multiple sessions by a same user, for example, like previously discussed. FIG. 8 shows interaction on the first interaction area 862 while the second interaction area 864 is awaiting further user input (e.g., via user interface elements 852, 854, 856), the same as or similar to previous discussions.

In the first interaction area 862, the display screen 800 shows a graphical depiction 812 of a property (e.g., a particular floor plan of a specific apartment) that may be disposed all or partially within an overlay 861 that may be transparent (e.g., partially transparent) in order for images, animations, videos, etc. to be at least partially viewable therebehind, the same as or similar to previous discussions. Similarly, navigation user elements (832, 828) may be provided, the same as or similar to previous discussions. In addition, a “like” or “favorite” user element 834 may be provided that allows a user to tag or otherwise mark a particular property as one of interest. For example, if a user has created a user account with the system (or, in certain embodiments, no user account may be necessary and the system may track “liked” residences for a given search session, for example, using Internet or browser “cookies”), upon tagging a property as a favorite, a list of the user's favorite properties may be tracked by the system and communicated to the user upon search completion, such as via an email, printout, final display screen, transmittal to a real estate agent for future follow-up, etc. In certain embodiments, one or more of the favorite items may be compiled into a brochure (e.g., hardcopy and/or digital) that is transmitted to the user to provide the user with a personalized pamphlet indicating all or some of the properties they desired most.

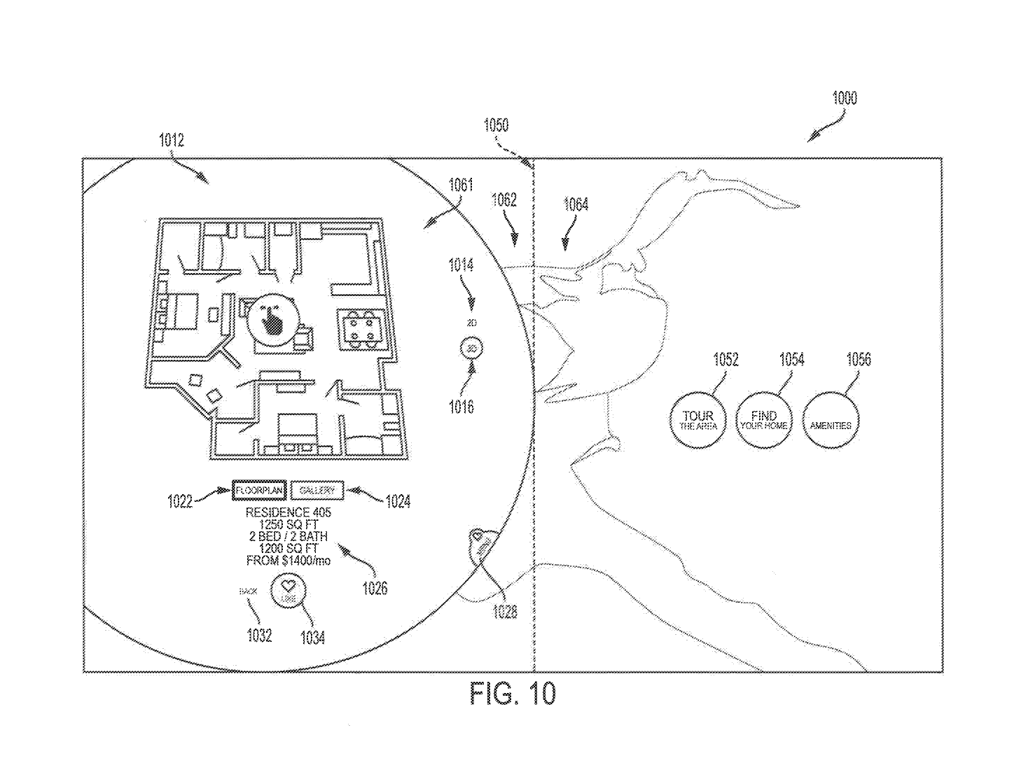

As illustrated, the display screen 800 shows a top-down, two-dimensional, view (e.g., rotatable in certain embodiments) of a floor plan of a particular property. As discussed in greater detail herein, if the user desires to switch to a three-dimensional view (e.g., see FIG. 10), the user may use navigational elements (814, 816) in order to switch therebetween. The two-dimensional view may include information (e.g., text, graphical depictions, etc.) thereon to make the floor plan space more apparent to the user, such as by identifying room types (e.g., sleep, relax, closet, entry, etc.) and/or by including furniture (e.g., beds, couches, etc.) to give the user a sense of space. Additional information 826 may be displayed upon the display screen 800 corresponding to the particular property so that the user can efficiently ascertain relevant info that may help in their purchasing and/or leasing decision.

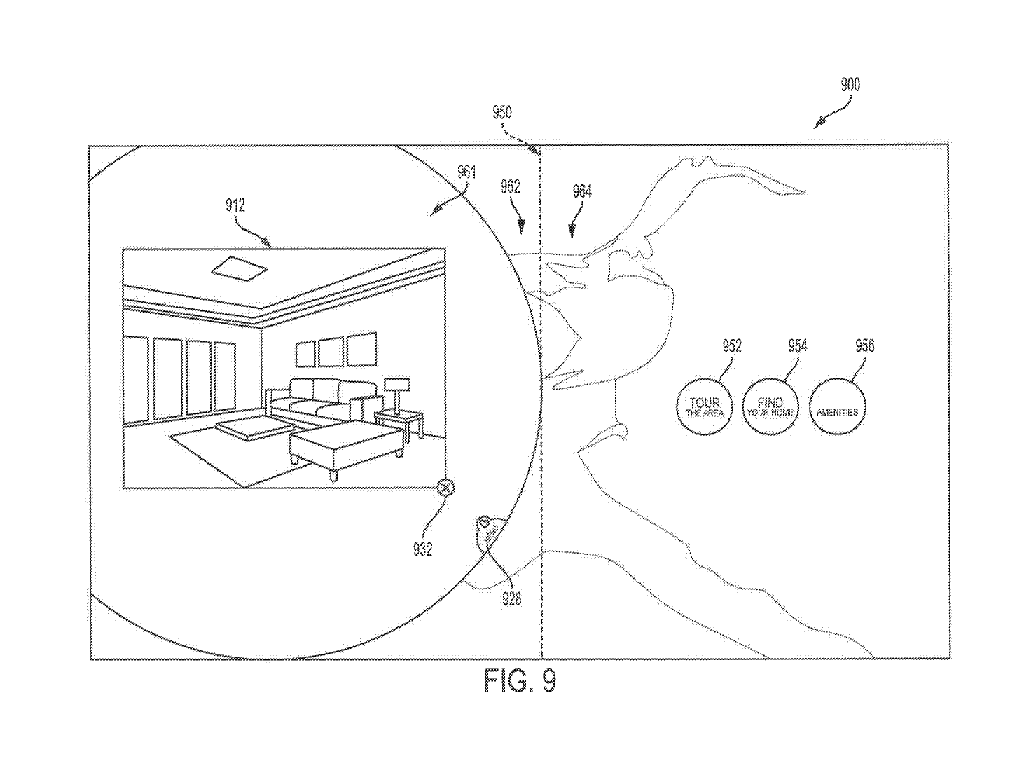

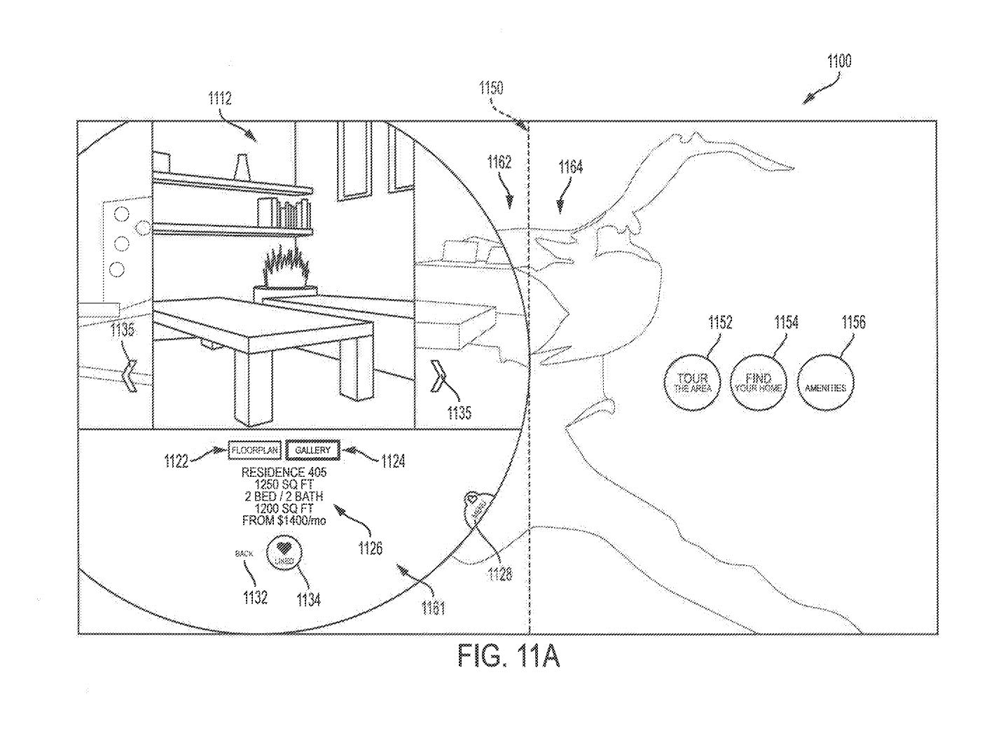

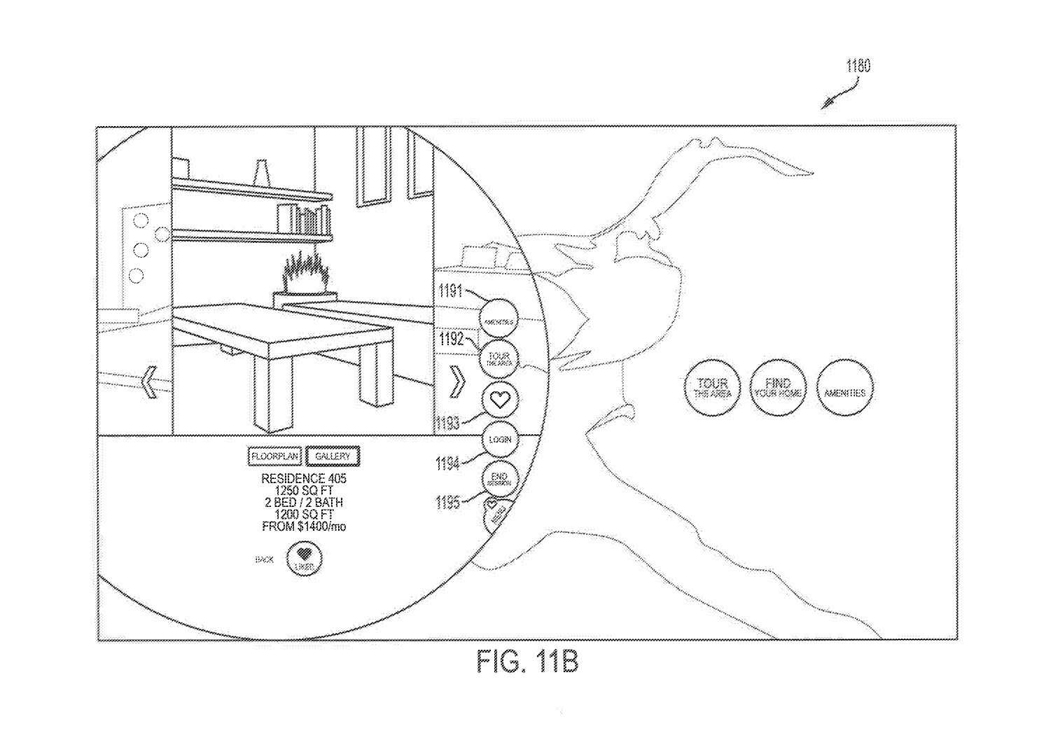

User interface elements (822, 824) may also be provided for allowing the user to switch between views of the floor plan for the property and one or more photographs or other images and/or videos (e.g., computer generated mock-ups) corresponding to the property (e.g., FIGS. 11A-11B). In addition, or alternatively, user interface elements 890 (e.g., represented as a graphical icon for a photograph) may be disposed at various locations within the floor plan view of the property and a user may be permitted to click upon a particular user interface element 890 to display a photograph or other image corresponding to the property at that location (e.g., see FIG. 9). Certain embodiments may allow for customizations of the property displayed to the user.

For example, the user may be able to choose or otherwise indicate a desired style for the property (e.g., contemporary, classic, boho, etc.) that would replace and/or update various of the flooring, furniture, or other aspects of the displayed property correspondingly to match the chosen style. In another example, the user may be permitted to choose or otherwise indicate a type of home or family situation that is desired (e.g., 1 adult bedroom and 1 office room versus 1 adult bedroom and 1 toddler room versus 2 adult bedrooms) and the floor plan view would be updated correspondingly. In another example, the user may be permitted to choose or otherwise indicate individual customizations, for example, choose a particular flooring type, a particular bed, a particular sofa, etc. from a list of available options to have those selections placed within the displayed floor plan. In still another example, a user may be able to customize not only the types of furniture or other objects, but also their arrangement or orientation (e.g., the user may be able to rotate and/or position a couch, table, etc. within a given room as desired). These customizations may have an aspect of automation (e.g., a user may pick a couch and a room for the couch, but the system determines final placement and/or orientation in the room) or may be completely manual for the user (e.g., the user may pick a couch and drag/drop it and/or rotate it into the specific position desired). Indeed, any of a variety of customizations may be allowed or requested by the user in various embodiments.

FIG. 9 shows a display screen 900 of a system implementing a real estate search software application. The display screen 900, system, and/or software application may include features that are the same as or similar to those previously discussed. For example, the display screen 900 may be displayed to a user based upon user interaction with a previous display screen (e.g., by pressing upon one or more user interface elements, such as user interface element 890, previously discussed in FIG. 8). As illustrated, the display screen 900 also includes multiple interaction areas (962, 964) that separate 950 the display screen 900 into independently interfacable screen spaces for accommodating multiple users and/or multiple sessions by a same user, for example, like previously discussed. FIG. 9 shows interaction on the first interaction area 962 while the second interaction area 964 is awaiting further user input (e.g., via user interface elements 952, 954, 956), the same as or similar to previous discussions.

In the first interaction area 962, the display screen 900 shows a photograph or image 912 of a property and/or of a particular area of the property (e.g., a photograph of a particular vantage point in a room of the property) that may be disposed all or partially within an overlay 961 that may be transparent (e.g., partially transparent) in order for images, animations, videos, etc. to be at least partially viewable therebehind, the same as or similar to previous discussions. Similarly, navigation user element 928 may be provided, the same as or similar to previous discussions. If a user wishes to close the photograph or image 912 and return to a floor plan view (e.g., see FIG. 8), the user may click a navigation user element 932.

FIG. 10 shows a display screen 1000 of a system implementing a real estate search software application. The display screen 1000, system, and/or software application may include features that are the same as or similar to those previously discussed. For example, the display screen 1000 may be displayed to a user as an initial property results screen and/or as a screen for property results that is displayed after providing overview search results information, for example, via other display screens such as those previously discussed (e.g., see FIG. 8). As illustrated, the display screen 1000 also includes multiple interaction areas (1062, 1064) that separate 1050 the display screen 1000 into independently interfacable screen spaces for accommodating multiple users and/or multiple sessions by a same user, for example, like previously discussed. FIG. 10 shows interaction on the first interaction area 1062 while the second interaction area 1064 is awaiting further user input (e.g., via user interface elements 1052, 1054, 1056), the same as or similar to previous discussions.

In the first interaction area 1062, the display screen 1000 shows a graphical depiction 1012 of a property (e.g., a particular floor plan of a specific apartment) that may be disposed all or partially within an overlay 1061 that may be transparent (e.g., partially transparent) in order for images, animations, videos, etc. to be at least partially viewable therebehind, the same as or similar to previous discussions. Similarly, navigation user elements (1032, 1028) may be provided, the same as or similar to previous discussions. In addition, a “like” or “favorite” user element 1034 may be provided that allows a user to tag or otherwise mark a particular property as one of interest, the same as or similar to previous discussions.

As illustrated, the display screen 1000 shows an isometric, three-dimensional, view (e.g., rotatable in certain embodiments) of a floor plan of a particular property. As previously discussed, if the user desires to switch to a two-dimensional view (e.g., see FIG. 8), the user may use navigational elements (1014, 1016) in order to switch therebetween. The three-dimensional view may include information (e.g., text, graphical depictions, etc.) thereon to make the floor plan space more apparent to the user, such as by identifying room types (e.g., sleep, relax, closet, entry, etc.) and/or by including furniture (e.g., beds, couches, etc.) to give the user a sense of space. Additional information 1026 may be displayed upon the display screen 1000 corresponding to the particular property so that the user can efficiently ascertain relevant info that may help in their purchasing and/or leasing decision.

User interface elements (1022, 1024) may also be provided for allowing the user to switch between views of the floor plan for the property and one or more photographs or other images or videos (e.g., computer generated mock-ups) corresponding to the property (e.g., FIGS. 11A-11B). As previously discussed for FIG. 8, in addition, or alternatively, user interface elements (not shown) may be disposed at various locations within the three-dimensional floor plan view of the property and a user may be permitted to click upon to display a photograph or other image corresponding to the property at that location. Certain embodiments may allow for customizations of the property displayed to the user.

For example, the user may be able to choose or otherwise indicate a desired style for the property (e.g., contemporary, classic, boho, etc.) that would replace and/or update various of the flooring, furniture, or other aspects of the displayed property correspondingly to match the chosen style. In another example, the user may be permitted to choose or otherwise indicate a type of home or family situation that is desired (e.g., 1 adult bedroom and 1 office room versus 1 adult bedroom and 1 toddler room versus 2 adult bedrooms) and the floor plan view would be updated correspondingly. In another example, the user may be permitted to choose or otherwise indicate individual customizations, for example, choose a particular flooring type, a particular bed, a particular sofa, etc. from a list of available options to have those selections placed within the displayed floor plan. In still another example, a user may be able to customize not only the types of furniture or other objects, but also their arrangement or orientation (e.g., the user may be able to rotate a couch, table, etc. within a given room as desired). Indeed, any of a variety of customizations may be allowed or requested by the user in various embodiments.

FIGS. 11A-11B show display screens (1100, 1180, respectively) of a system implementing a real estate search software application. The display screens (1100, 1180), system, and/or software application may include features that are the same as or similar to those previously discussed. For example, the display screen 1100 may be displayed to a user based upon user interaction with a previous display screen (e.g., by pressing upon one or more user interface elements, such as user interface element 1024, previously discussed in FIG. 10). As illustrated, the display screen 1100 also includes multiple interaction areas (1162, 1164) that separate 1150 the display screen 1100 into independently interfacable screen spaces for accommodating multiple users and/or multiple sessions by a same user, for example, like previously discussed. FIG. 11A shows interaction on the first interaction area 1162 while the second interaction area 1164 is awaiting further user input (e.g., via user interface elements 1152, 1154, 1156), the same as or similar to previous discussions.

In the first interaction area 1162, the display screen 1100 shows a photograph or image 1112 of a property and/or of a particular area of the property (e.g., a photograph of a particular vantage point in a room of the property) that may be disposed all or partially within an overlay 1161 that may be transparent (e.g., partially transparent) in order for images, animations, videos, etc. to be at least partially viewable therebehind, the same as or similar to previous discussions. Similarly, navigation user elements (1132, 1128) may be provided, the same as or similar to previous discussions. In addition, a “like” or “favorite” user element 1134 may be provided that allows a user to tag or otherwise mark a particular property as one of interest, the same as or similar to previous discussions.

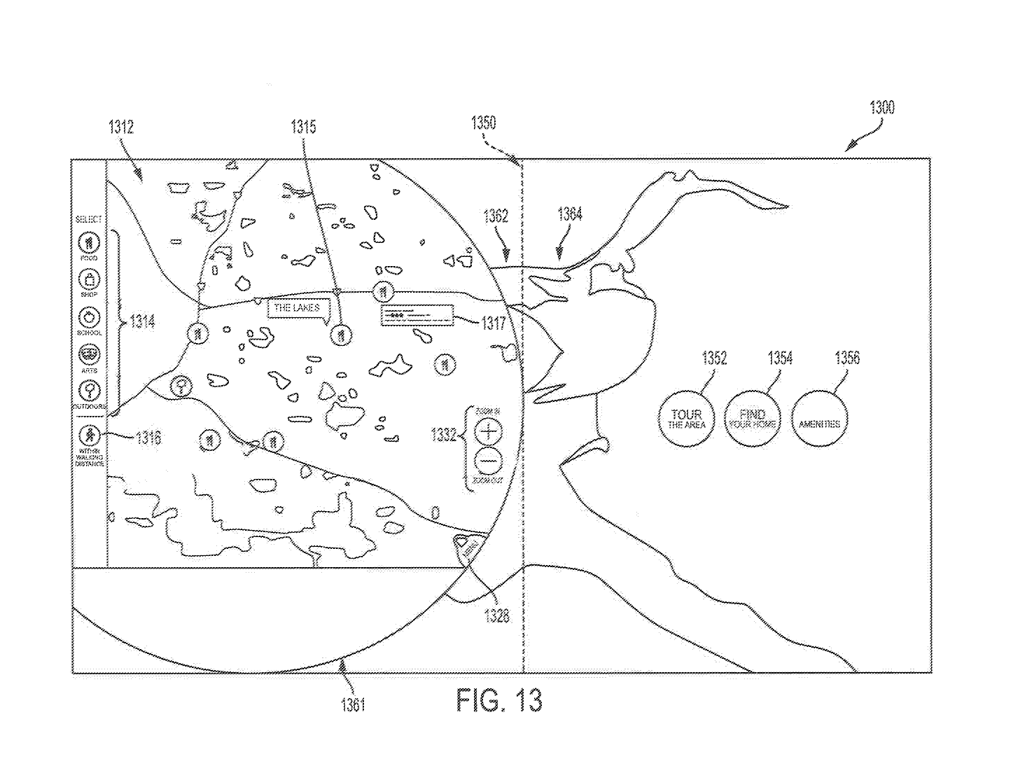

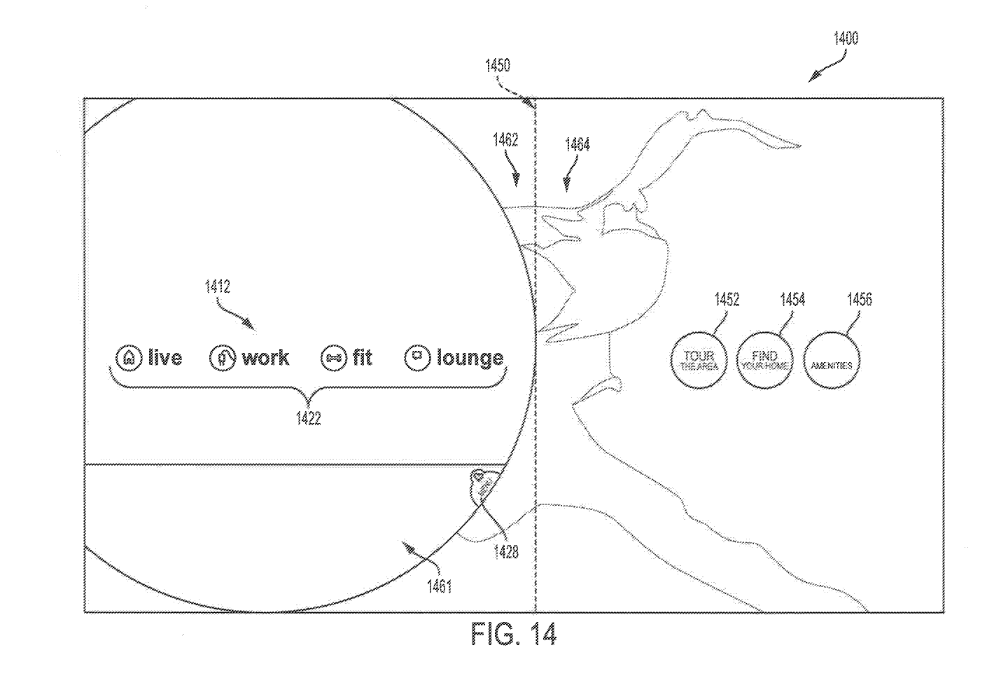

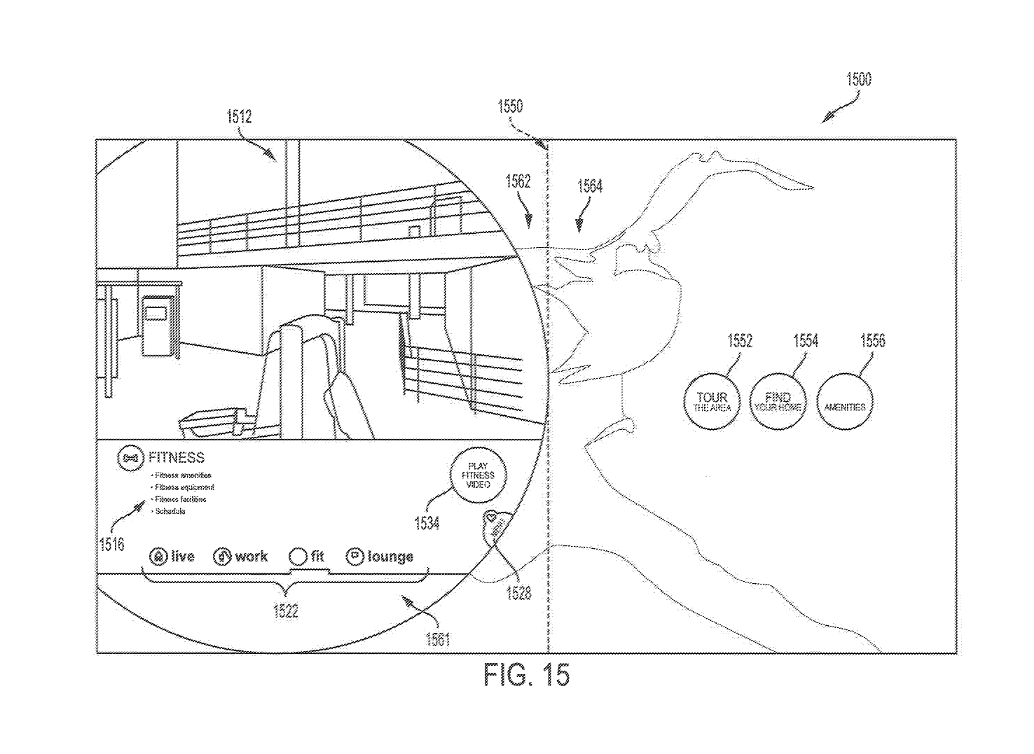

Further, navigation elements (1122, 1124, 1134, 1135) may be provided for allowing a user to switch between floor plan and gallery views, as previously discussed and/or cycle through a plurality of photographs and/or images, respectively. Additional information 1126 may be displayed about the property corresponding to the photograph or image 1112 as previously discussed. The display screen 1180 of FIG. 11B shows the same or similar display of FIG. 11A, but introduces a plurality of additional user interface elements (1191, 1192, 1193, 1194, 1195), for example, that may be displayed when the user presses upon an area of the display screen 1100 of FIG. 11A. These user interface elements (1191, 1192, 1193, 1194, 1195) may allow the user to view amenities corresponding to the property (e.g., see FIGS. 14-15), view or tour surrounding area features (e.g., see FIG. 13), like the corresponding property, log in to a user account (discussed in greater detail herein), or end the current session, respectively.

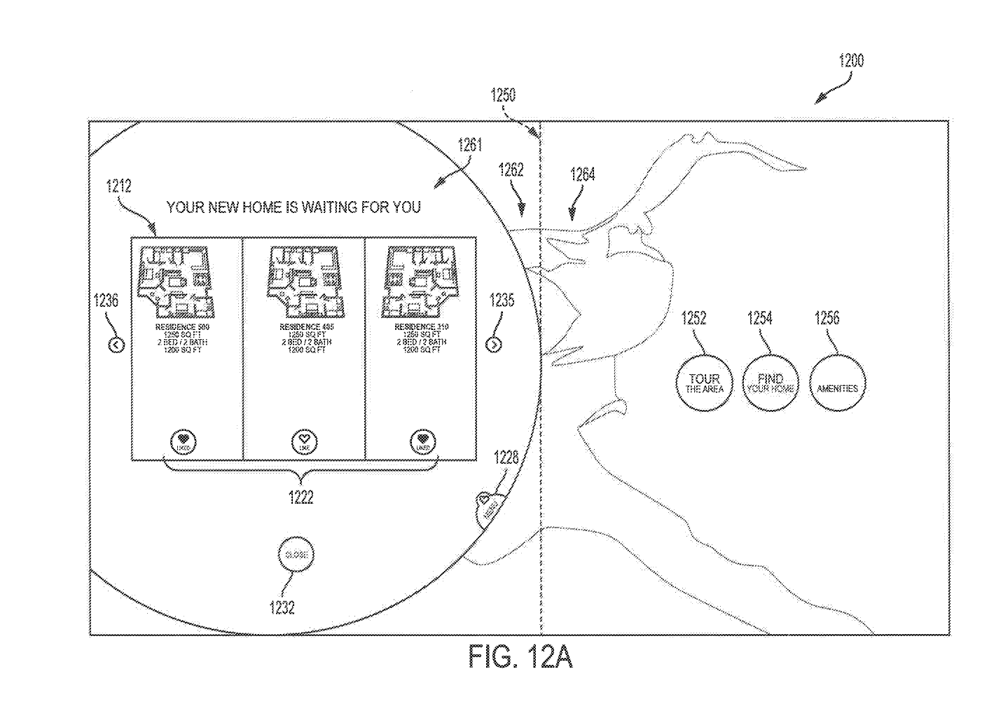

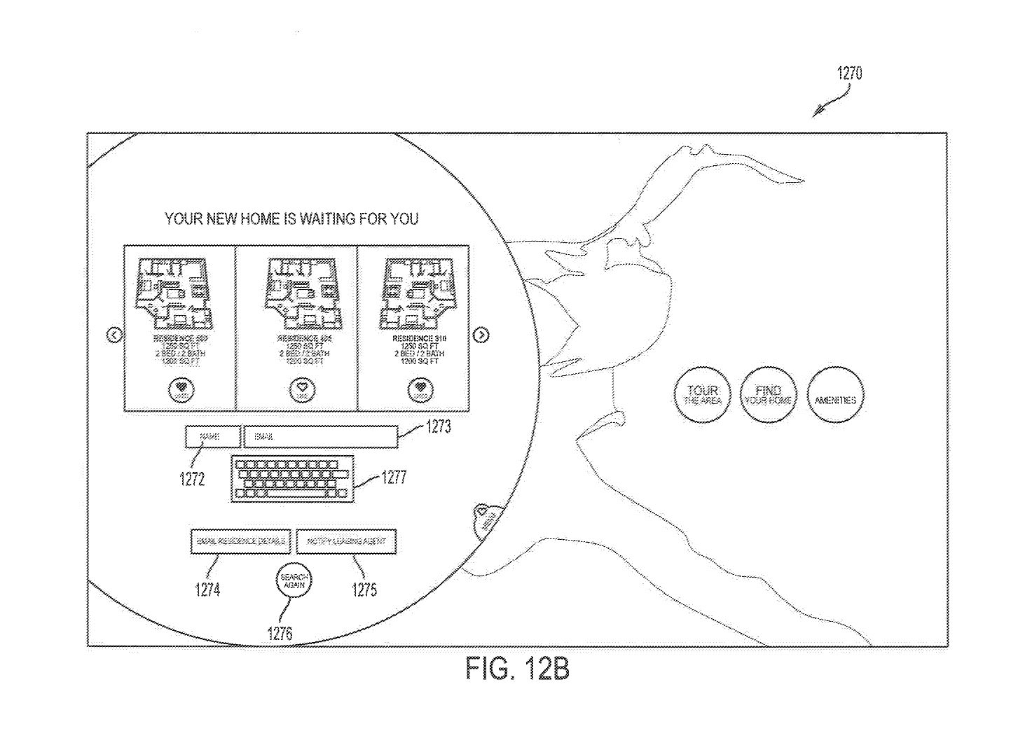

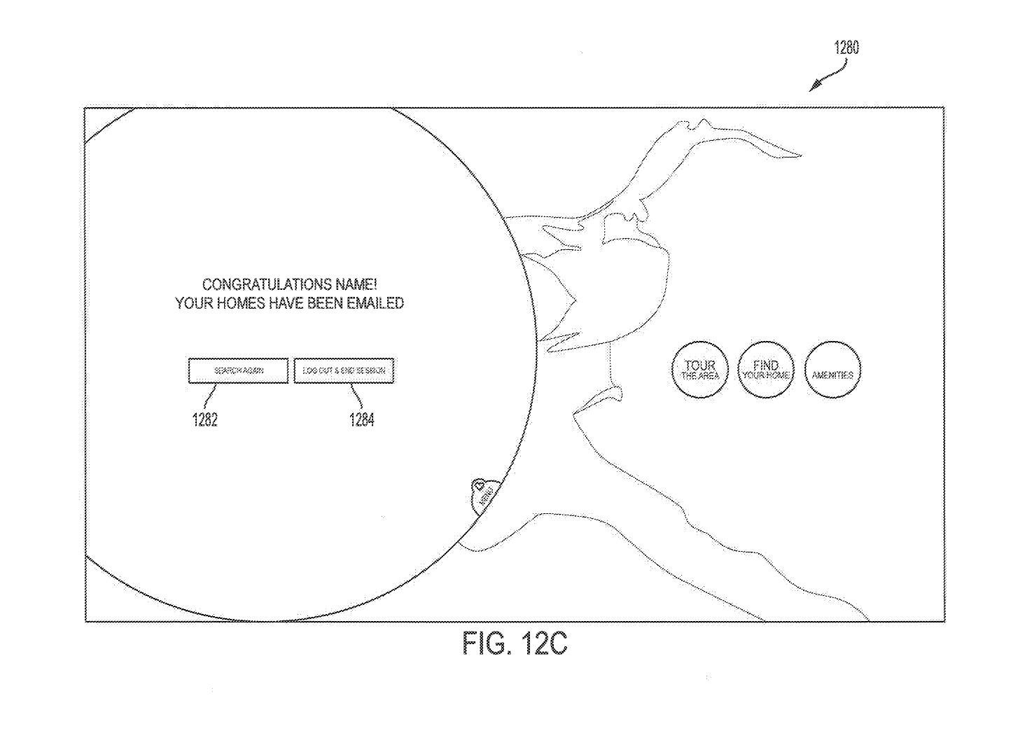

FIGS. 12A-12C show display screens (1200, 1270, 1280) of a system implementing a real estate search software application. The display screens (1200, 1270, 1280), system, and/or software application may include features that are the same as or similar to those previously discussed. For example, the display screen 1200 may be displayed to a user as an initial property results screen and/or as a screen for property results that is displayed after providing overview search results information, for example, via other display screens such as those previously discussed. As illustrated, the display screen 1200 also includes multiple interaction areas (1262, 1264) that separate 1250 the display screen 1200 into independently interfacable screen spaces for accommodating multiple users and/or multiple sessions by a same user, for example, like previously discussed. FIG. 12A shows interaction on the first interaction area 1262 while the second interaction area 1264 is awaiting further user input (e.g., via user interface elements 1252, 1254, 1256), the same as or similar to previous discussions.

In the first interaction area 1262, the display screen 1200 shows a graphical depiction 1212 of one or more properties that may be disposed all or partially within an overlay 1261 that may be transparent (e.g., partially transparent) in order for images, animations, videos, etc. to be at least partially viewable therebehind, the same as or similar to previous discussions. Navigation user elements (1235, 1236) may be provided for allowing a user to scroll through the one or more properties if all of the properties do not fit upon one display screen space. Similarly, navigation user elements (1232, 1228) may be provided, the same as or similar to previous discussions. For example, if a user wishes to close their search session, the user may interface with navigation user element 1232. In addition, one or more “like” or “favorite” user elements 1222 may be provided that allows a user to tag or otherwise mark one or more properties as one of interest, the same as or similar to previous discussions.

As illustrated, the display screen 1200 includes a plurality of property or residence matches 1212 displayed and/or designated and that were determined via the system by comparing one or more desired user inputs or criteria (e.g., as previously discussed) to store information about one or more properties (e.g., within a memory or database of or connected with the system). In certain embodiments, additional information about a particular property or residence match may be displayed or otherwise communicated to a user if the user interfaces (e.g., presses) upon the property or residence match.

The display screen 1270 of FIG. 12B is the same as FIG. 12A, but includes additional user interface elements. As illustrated, a user interface element 1272 may be provided for allowing a user to enter their name, a user interface element 1273 may be provided for allowing a user to enter their email address (e.g., or other contact information, such as physical address and/or telephone number), for example, via a virtual keyboard 1277 or other interface manner (e.g., voice recognition). For example, this name and contact information may be used for personalizing a communication to the user with one or more of the property selections and/or for use in a communication to a leasing or other real estate agent or company. As illustrated, an additional user interface element 1274 may be provided for the user to select that one or more of the matching properties and/or their corresponding information be sent to the user (e.g., via the contact information provided via user interface element 1273. In addition, a user interface element 1275 may be provided for the user to opt to send one or more of the matching properties and/or their corresponding information and/or user information to a third party (such as a leasing agent).

The display screen 1280 of FIG. 12C may be displayed subsequent to another display screen, for example, the display screen of FIG. 12B. As illustrated, display screen 1280 includes a first user interface element 1282 that allows a user to begin or continue with a different search and a second user interface element 1284 that ends the current search and/or logs the user out of their user account, if one exists.

Turning next to FIG. 13, a display screen 1300 of a system implementing a real estate search software application is shown. The display screen 1300, system, and/or software application may include features that are the same as or similar to those previously discussed. For example, the display screen 1300 may be displayed to a user upon receipt of user input indicating that the user desires to find out information about a particular geographic area (e.g., an area near a property of interest). This may occur, for example, by pressing upon one or more user interface elements, such as user interface element 102, previously discussed in FIG. 1. As illustrated, the display screen 1300 also includes multiple interaction areas (1362, 1364) that separate 1350 the display screen 1300 into independently interfacable screen spaces for accommodating multiple users and/or multiple sessions by a same user, for example, like previously discussed. FIG. 13 shows interaction on the first interaction area 1362 while the second interaction area 1364 is awaiting further user input (e.g., via user interface elements 1352, 1354, 1356), the same as or similar to previous discussions.

In the first interaction area 1362, the display screen 1300 shows a graphical depiction 1312 of a geographic area (e.g., an area, such as a map, surrounding or including a particular property or group of properties). In one embodiment, this graphical depiction 1312 may be disposed all or partially within an overlay 1361 that may be transparent (e.g., partially transparent) in order for images, animations, videos, etc. to be at least partially viewable therebehind. A user may be permitted to manipulate (e.g., rotate, zoom, scroll, etc.) this graphical depiction 1312 by interfacing with the graphical depiction 1312 (e.g., dragging, spinning, etc. with the user's finger(s)) and/or by manipulating user interface elements 1332.

One or more user interface elements 1314 may be provided for allowing a user to select the types of activities and/or features of the geographic area of interest and to be displayed upon the graphical depiction 1312. For example, and as illustrated, separate interface elements 1314 may be provided for enabling/disabling of food, shopping, schools, arts, outdoor features, etc. that, when enabled produce corresponding icons 1315 at their geographic location on the graphical depiction 1312. In certain embodiments, pressing or otherwise interfacing with these icons 1315 may display additional information 1317 to the user about the specific icon 1315 (e.g., if a particular icon 1315 represents “food,” pressing upon that particular icon may pop up a window or screen with a restaurant name, address, hours of operation, etc.). In certain embodiments, an interface element 1316 may be interfaced with to establish a particular range for which icons will be displayed upon the graphical depiction 1312 (e.g., within walking distance, within 5 miles, etc.)

Lastly, turning next to FIGS. 14 and 15, display screens (1400, 1500) of a system implementing a real estate search software application is shown. The display screens (1400, 1500), system, and/or software application may include features that are the same as or similar to those previously discussed. For example, the display screen 1400 may be displayed to a user upon receipt of user input indicating that the user desires to find out information about amenities available for a particular residence. This may occur, for example, by pressing upon one or more user interface elements, such as user interface element 106, previously discussed in FIG. 1. As illustrated, the display screen 1400 also includes multiple interaction areas (1462, 1464) that separate 1450 the display screen 1400 into independently interfacable screen spaces for accommodating multiple users and/or multiple sessions by a same user, for example, like previously discussed. FIG. 14 shows interaction on the first interaction area 1462 while the second interaction area 1464 is awaiting further user input (e.g., via user interface elements 1452, 1454, 1456), the same as or similar to previous discussions.

In the first interaction area 1462, the display screen 1400 shows a graphical depiction 1412 of one or more possible amenity categories 1422 (e.g., live, work, fit, lounge, etc.) that may be available for a residence. In one embodiment, this graphical depiction 1412 may be disposed all or partially within an overlay 1461 that may be transparent (e.g., partially transparent) in order for images, animations, videos, etc. to be at least partially viewable therebehind. A user may be permitted to press or otherwise interface with the categories 1422 in order to see amenities that may be available for a property that correspond to such category. A navigation user element 1428 may be pressed that allows the user to go back to a main system menu.

The display screen 1500 of FIG. 15 may be displayed subsequent to another display screen, for example, the display screen of FIG. 14, such as by pressing upon one or more user interface elements, (e.g., the “Fit” category 1422). As illustrated, the display screen 1500 includes multiple interaction areas (1562, 1564) that separate 1550 the display screen 1500 into independently interfacable screen spaces for accommodating multiple users and/or multiple sessions by a same user, for example, like previously discussed. FIG. 15 shows interaction on the first interaction area 1562 while the second interaction area 1564 is awaiting further user input (e.g., via user interface elements 1552, 1554, 1556), the same as or similar to previous discussions.

In the first interaction area 1562, the display screen 1500 shows a graphical depiction 1512 of one or more possible amenities (e.g., amenities that correspond to a particular category, such as a fitness category, that may be available for a residence. The graphical depiction 1512 may include text 1516 describing the amenity and/or any of a variety of other manners for communicating such features to the user. In one embodiment, this graphical depiction 1512 may be disposed all or partially within an overlay 1561 that may be transparent (e.g., partially transparent) in order for images, animations, videos, etc. to be at least partially viewable therebehind. A user may be permitted to press or otherwise interface a user interface element 1534 in order to see additional amenity information (e.g., illustrated in the embodiment of FIG. 15 as a video). In an alternative embodiment, any of a variety of information (e.g., pictures, text, animations, etc.), or no additional information, may be available for viewing. In one embodiment, as illustrated, the user may be permitted to switch or select another category 1522 or amenity by interfacing (e.g., pressing or clicking) upon such category. A navigation user element 1528 may be pressed that allows the user to go back to a main system menu.

The previously discussed system and/or mobile or software application may include features and/or operation different from those stated in the exemplary embodiments detailed above. Features and/or operation in one embodiment may also or additionally be included with features and/or operation of a separately discussed embodiment. Moreover, features may be added, removed, or executed with different operative flow from the exemplary embodiments detailed above. In one embodiment, the software application may be envisioned to only be viewed by one user at a time (e.g., upon a mobile device such as a smart phone, tablet, etc.) such that the previously-described features of multiple users capable of interacting upon one display screen is not a needed or desired feature.

In certain embodiments, as illustrated in some of the exemplary figures, the software application may be envisioned to be viewed on one or more of a large, high resolution (e.g., equal to or greater than 1920×1080 such as a 4K display). In alternative embodiments, any display resolution may be used. Multiple users may be configured to interact with the one or more displays simultaneously, wither in cooperation with one another on a same interaction area or on different interaction areas that do not communicate and cooperate with one another.

Sound may be featured as part of the software application (e.g., when a user interacts with a display screen, various query, confirmation, and/or other tones, sounds, or spoken words are presented to the user). In one embodiment, if multiple users are interfacing with the software application in proximity to one another (e.g., on one large display), the sound may be different for each user and/or transmitted to the user such that surrounding users are less likely to hear it (e.g., using directional sound hardware). In certain embodiments, motion may be sensed such that the software application responds (e.g., brings up a main menu) upon sensing that a user has walked up to a display screen or is looking at a display screen.

In another example, in one embodiment and as mentioned previously mentioned, the software application may be configured to allow a user to register (e.g., create an account) therewith. Having such an account, various user properties and/or preference data may be stored and/or linked therewith, such that a user may store commonly-used search criteria or other information (such as “liked” or “favorited” properties). In one example, a user having a user account may be configured to receive notifications (e.g., pop-up notifications on a device running the same or a corresponding software application, emails, text messages, etc.) based on stored criteria and/or past searches, such as when a new home or real estate property comes on the market that contains one or more criteria that matches a desired feature for the user.

In addition, in certain embodiments, usage of the software application may be tracked, stored, and/or analyzed to gather and/or provide market data. For example, based upon tracking of one or more user criteria that is searched using the software application, market data or statistics may be generated (e.g., “90% of all users search for a property that is greater than 2000 square feet within a given zip code” or “most buyers in a given zip code search for home under a particular price point). Such gathered market data can be useful for builders or other real estate planners to know what criteria customers (e.g., customers looking within a particular geographic region) tend to desire with more regularity, allowing for new homes or renovations to be undertaken with such criteria in mind.

In certain embodiments, the software application may be configured to act as a hub for various real estate searching, purchasing/leasing and/or other activities. In one example, the software application may allow a user to search for desired real estate properties and/or corporate rooms for booking and/or lease, for example, by allowing a user to search, browse, or otherwise indicate to the software application a desired location or criteria of interest. In another example, the software application may include additional and/or alternative features associated with allowing residents/purchasers of a property to pay the rent or mortgage bill via the software application. In still another example, the software application may include features associated with allowing residents/purchasers of a property to request services be performed (e.g., request maintenance for the residence, such as electrical, mechanical, plumbing services, and/or FedEx or other delivery requests). In yet another embodiment, the software application may provide or display a calendar to the user that can save one or more appointments for the user.

Such software applications can either be configured to run upon a hardware kiosk, stand, wall or setup and/or configured to run in a more individual environment, such as on a user's smart phone, tablet, wearable, personal computer, etc. By including one or more of such features into the software application, residents may become more accustomed (or, for example, may be required to pay the rent via the application), thus ensuring that the software application is being regularly used by the residents. For example, such regular usage by an audience may promote advertising or other monetary generating capabilities to be built into the software, as discussed in greater detail below.

Other features, in addition to or in replacement of those previously described may be incorporated into the software application, for example, to further encourage regular use by residents. For example, a property may be outfitted with one or more “smart” fixtures or systems that can be interacted with via the software application, such as lights (e.g., turning them on/off or adjusting their dimness, colors, etc.), fans or other air movement devices like air-conditioning or heaters (e.g., turning them on/off, establishing a schedule for their turn on/off, adjusting temperatures, etc.), alarm systems (e.g., turning on/off, establishing a schedule for its turn on/off, adjusting codes, etc.), shades (e.g., lowering/raising window shades, etc.). Any of a variety of controllable fixtures, components, and/or other systems may be configured to be remotely interfaced with via the software application in alternative embodiments.

This regular usage may allow for the software application to incorporate a variety of additional monetization. For example, the software application may be configured to include features that allow users to browse/search for nearby activities or places of interest. Such features may incorporate paid-for placement of products, activities, events, etc. from third party companies. Thus, for example, if a user of the software application is interested in finding something to do nearby to their residence, they may open up the software application, browse upcoming events within geographic proximity, and be displayed a variety of locations/activities/events. These events may be displayed without having been additionally paid for by its owner (e.g., a mere listing of a business within the surrounding geography) or may be paid for (e.g., placement or higher placement or more prominently displayed to the user). As one example, an amusement park that is within a geographic proximity may always be displayed to users browsing for nearby activities, but, if the owner of the amusement park pays for more prominent display, this amusement park may be highlighted, placed higher in a nearby activities list, have additional information associated with it that is displayed to the user, etc. Indeed, any of a variety of advertisements, product or service placements, coupons, etc. may be incorporated into the monetized software hub.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

What is claimed is:

1. An apparatus for providing information comprising:
a display configured to receive user input via touch of the display, the display configured to have a first interaction area and a second interaction area wherein a first user can interact with the first interaction area while a second user can simultaneously interact with a second interaction area;
a memory configured to store data; and
a processor in communication with the memory and the display and configured to:
receive a first search request,
determine a portion of the data in the memory that matches the first search request, and
transmit to the display at least some of the portion of the data that matches the first search request.

2. The apparatus of claim 1 wherein the display is a single display screen having a resolution of at least 4096×2160 pixels.

3. The apparatus of claim 1 wherein the data is real estate data.

4. The apparatus of claim 1 wherein the first search request comprises a desired number of bedrooms.

5. The apparatus of claim 1 wherein the first search request comprises desired pricing.

6. The apparatus of claim 1 wherein the first search request comprises desired square footage.

7. A method of providing search results for real estate to a user, the method comprising the steps of:
providing a software application configured to be executed by a processor;
providing a memory for storing data corresponding to a plurality of real estate properties;
determining, using the processor, a first search request;
determining, using the processor, a second search request simultaneously with the determining of the first search request;
determining, using the processor, a first data in the memory that matches with the first search request; and
displaying information associated with the first data.

8. The method of claim 7 further comprising providing a display in communication with the processor for displaying a user interface of the software application.

9. The method of claim 8 wherein the display is configured to receive input from the user via touch of the display by the user.

10. The method of claim 9 wherein the first search request is configured to be determined via a first interaction area of the display and the second search request is configured to be determined via a second interaction area of the display.

11. The method of claim 7 wherein displaying information associated with the first data includes displaying a graphical depiction of a real estate property corresponding to the first data.

12. The method of claim 11 wherein the graphical depiction is a two-dimensional image.

13. The method of claim 12 wherein the two-dimensional image comprises a top-down view of the real estate property.

14. The method of claim 13 wherein the top-down view is configured to be customized by the user with selectable (1) furniture, (2) flooring styles, or (3) countertops.

15. The method of claim 13 wherein the top-down view is configured to be customized by the user with predetermined styles for the real estate property.

16. The method of claim 11 wherein the graphical depiction is a three-dimensional floorplan.

17. The method of claim 16 wherein the three-dimensional floorplan is configured to be populated with user-selectable furniture objects.

18. A method of providing information to a user regarding a property comprising
providing a software application configured to be executed by a processor;
receiving, via the software application, a service request from the user corresponding to the property;
displaying, via the software application, confirmation of the service request;
receiving, via the software application, a payment from the user for the property;
displaying, via the software application, confirmation of the payment;
displaying, via the software application, an activity to the user, the activity located within a predetermined geographic proximity to the property; and
displaying, via the software application, an advertisement to the user.

19. The method of claim 18 wherein the advertisement is paid for by a third party.

20. The method of claim 18 wherein the displaying of the activity to the user comprises displaying a map and an icon corresponding to the activity.

21. A method of providing information to a user regarding a property comprising
providing a software application configured to be executed by a processor;
providing a memory for storing data in communication with the processor,
receiving, by the processor, price criteria from the user corresponding to a search request; and
determining, by the processor, a portion of the data in the memory that is within a predetermined range of the pricing information received by the processor.
